(19) United States
(12) Patent Application Publication
(10) Pub. No.: US 2026/0359068 A1
(43) Pub. Date: Nov. 12, 2026

(54) SYSTEM ON CHIP THAT ACHIEVES FAST BOOT UP OF ELECTRONIC DEVICE WITH AID OF RETENTION MECHANISM

(71) Applicant: MEDIATEK INC., Hsinchu City (TW)

(72) Inventors: Yu-Jia Liang, Hsinchu City (TW); Chin-Te Chen, Hsinchu City (TW); Hung-Lin Chang, Hsinchu City (TW); Pan-Yen Chiang, Hsinchu City (TW); Hsuan-Chang Chen, Hsinchu City (TW); Yuan-Jung Kuo, Hsinchu City (TW); Zhong-Han Wu, Hsinchu City (TW); Jia-Ru Li, Hsinchu City (TW)

(73) Assignee: MEDIATEK INC., Hsinchu City (TW)

(21) Appl. No.: 19/475,044

(22) PCT Filed: Nov. 7, 2024
(86) PCT No.: PCT/CN2024/130366

§ 371 Date: Oct. 13, 2025

Related U.S. Application Data
(60) Provisional application No. 63/598,163, filed on Nov. 13, 2023.

(51) Int. Cl. G06F 9/4401

(52) U.S. Cl. CPC G06F 9/4416

(57) ABSTRACT

A system on chip (SoC) includes a memory device and a processing circuit. The processing circuit is arranged to retain at least one boot up information in the memory device before the SoC is powered off in response to a command from an application processor (AP), wherein the command indicates that an electronic device comprising the SoC enters a fast boot mode, and the electronic device is booted up according to the at least one boot up information.

### CROSS REFERENCE TO RELATED APPLICATION

This application claims the benefit of U.S. Provisional Application No. 63/598,163, filed on Nov. 13, 2023. The content of the application is incorporated herein by reference.

### BACKGROUND OF THE INVENTION

### 1. Field of the Invention

The present invention is related to a system on chip (SoC), and more particularly, to a radiofrequency (RF) SoC that achieves fast boot up of an electronic device with aid of a retention mechanism, an associated method, and an associated electronic device.

### 2. Description of the Prior Art

A boot mode of a conventional electronic device equipped with an RF SoC may include a cold boot mode and an RF on/off mode, wherein in the RF on/off mode, an RF SoC is not powered off during a power off event of the electronic device; and in the cold boot mode, some contexts stored in a memory device may be reset to 0's before the electronic device is powered on. When the electronic device enters the cold boot mode or the RF on/off mode, the electronic device is required to perform a de-registration procedure with a network device. When the electronic device leaves the cold boot mode or the RF on/off mode, the electronic device is required to perform an initial registration procedure with the network device. Both procedures may delay the boot time of the electronic device. During a short time period after the electronic device is powered off, the above-mentioned two boot modes may cause higher power consumption for rebooting. Furthermore, if the electronic device frequently enters the cold boot mode or the RF on/off mode for saving power, the network device will receive a large number of over-the-air (OTA) messages (i.e., a message storm phenomenon may occur at the network device), thus causing a burden on the network device.

As a result, a novel RF SoC that can achieve fast boot up of an electronic device with aid of a retention mechanism is urgently needed, in order to accelerate the boot time and achieve lower power consumption for re-booting during the short time period after the electronic device is powered off.

### SUMMARY OF THE INVENTION

It is therefore one of the objectives of the present invention to provide an RF SoC than can achieve fast boot up of an electronic device with aid of a retention mechanism, an associated method, and an associated electronic device, in order to address the above-mentioned issues.

According to an embodiment of the present invention, an SoC is provided. The SoC comprises a memory device and a processing circuit. The processing circuit is arranged to retain at least one boot up information in the memory device before the SoC is powered off in response to a command from an application processor (AP), wherein the command indicates that an electronic device comprising the SoC enters a fast boot mode, and the electronic device is booted up according to the at least one boot up information.

According to an embodiment of the present invention, a method for booting up an electronic device is provided. The method comprises: receiving a command from an AP, wherein the command indicates that the electronic device enters a fast boot mode; and in response to reception of the command from the AP, retaining at least one boot up information in a memory device before the electronic device is powered off, wherein the electronic device is booted up according to the at least one boot up information.

According to an embodiment of the present invention, an electronic device is provided. The electronic device comprises an AP and an SoC. The AP is arranged to generate a command for indicating that the electronic device enters a fast boot mode. The SoC comprises a memory device and a processing circuit, wherein in response to reception of the command from the AP, the processing circuit retains at least one boot up information in the memory device before the electronic device is powered off, and the electronic device is booted up according to the at least one boot up information.

One of the benefits of the present invention is that, an RF SoC of the present invention and an associated method can achieve fast boot up of an electronic device with aid of a retention mechanism, which can accelerate the boot time and achieve lower power consumption for re-booting during a short time period after the electronic device is powered off. In addition, compared with a case where the electronic device frequently enters a cold boot mode or an RF on/off mode, the electronic device equipped with the RF SoC of the present invention will not burden on the network device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an entering phase of a fast boot mode with a retention mechanism according to an embodiment of the present invention.

FIG. 3 is a diagram illustrating a leaving phase of a fast boot mode with a retention mechanism according to an embodiment of the present invention.

FIG. 4 is a diagram illustrating a registration status between an electronic device and a network device according to an embodiment of the present invention.

FIG. 5 is a diagram illustrating a resume mechanism of a timer according to an embodiment of the present invention.

FIG. 6 is a diagram illustrating power consumption of different boot modes of an electronic device according to an embodiment of the present invention.

FIG. 7 is a flow chart of a method for booting up an electronic device with aid of a retention mechanism according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”

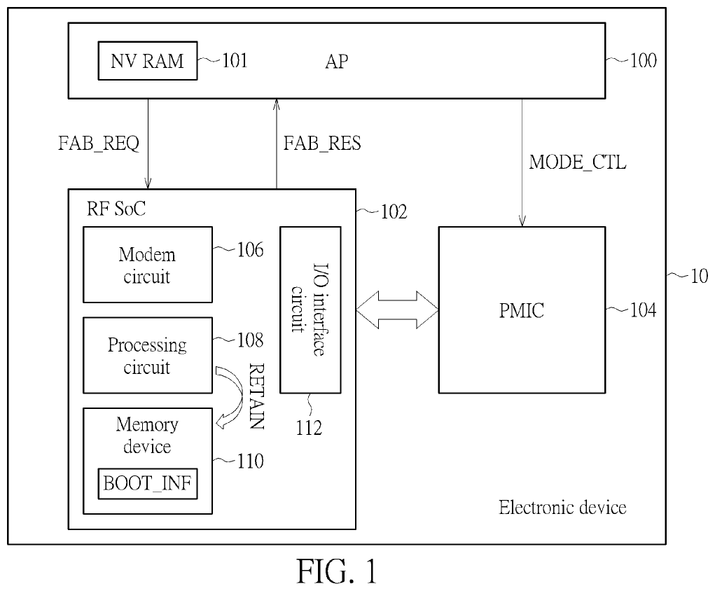

FIG. 1 is a diagram illustrating an electronic device 10 according to an embodiment of the present invention. By way of example, but not limitation, the electronic device 10 may be a portable device such as a smartphone or a tablet. The electronic device 10 may include an management integrated circuit (PMIC) 104. The RF SoC 102 may have a plurality of circuits, including a modulator/demodulator (modem) circuit 106, a processing circuit 108, a memory device 110, and an input/output (I/O) interface circuit 112, wherein the memory device 110 may be a dynamic random access memory (DRAM).

Both the AP 100 and the PMIC 104 may communicate with the RF SoC 102 via the I/O interface circuit 112. For example, the I/O interface circuit 112 may include general-purpose input/output (GPIO) hardware and peripheral component interconnect express (PCIe) hardware. The AP 100 may be arranged to generate and transmit a command and a control signal MODE_CTL to the RF SoC 102 and the PMIC 104, respectively, for activation of a fast boot mode of the electronic device 10 (i.e., a mode of the electronic device 10 is switched from a normal mode to the fast boot mode).

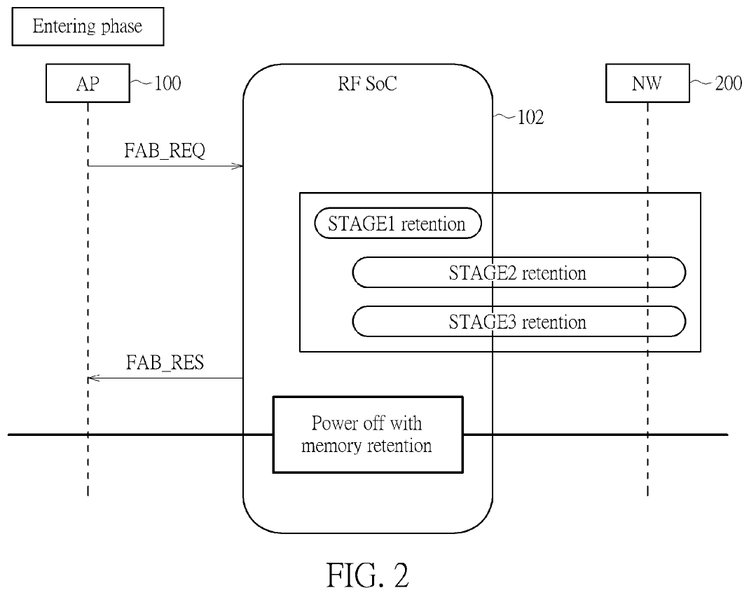

The AP 100 may run an application to generate and transmit a fast boot request FAB_REQ to the RF SoC 102, wherein the fast boot request FAB_REQ indicates that the electronic device 10 prepares to enter the fast boot mode. During an entering phase of the fast boot mode, the processing circuit 108 may retain at least one boot up information BOOT_INF in the memory device 110 (labeled as “RETAIN” in FIG. 1), wherein the electronic device 10 may be booted up according to the at least one boot up information BOOT_INF. Specifically, refer to FIG. 2. FIG. 2 is a diagram illustrating an entering phase of a fast boot mode with a retention mechanism according to an embodiment of the present invention. As shown in FIG. 2, in the beginning, the AP 100 may transmit the fast boot request FAB_REQ to the RF SoC 102 for notifying the RF SoC 102 of starting to perform at least one retention operation. For example, the RF SoC 102 may retain the at least one boot up information BOOT_INF in the memory device 110 before the RF SoC 102 is powered off, in order to avoid resetting the at least one boot up information BOOT_INF before powering on the electronic device 10. In this embodiment, the retention mechanism may have three stages (e.g., stages STAGE1, STAGE2, and STAGE3, which are labeled as “STAGE1 retention”, “STAGE2 retention”, and “STAGE3 retention” in FIG. 2, respectively), and the processing circuit 108 may adopt the retention mechanism with different stages, depending upon the actual design requirements.

In the stage STAGE1, the processing circuit 108 may preload non-volatile (NV) data from an NV RAM 101 of the AP 100 into the memory device 110 before the RF SoC 102 is powered data during the subsequent boot process. In this way, the time required to interact with the AP 100 for obtaining the NV data in a leaving phase of the fast boot mode can be saved, thereby reducing the boot time. In addition, the processing circuit 108 may retain data read/accessed from a subscriber identity module (SIM) within the modem circuit 106 in the memory device 110 before the RF SoC 102 is powered off, in order to reduce the time for subsequent access to the SIM in the leaving phase. The at least one boot up information BOOT_INF may include the NV data retrieved from the AP 100 and the data read/accessed from the SIM in the stage STAGE1.

In the stage STAGE2, before the RF SoC 102 is powered off, the RF SoC 102 will not perform a de-registration procedure with a network device 200 (denoted by “NW” in FIG. 2 for brevity), and the processing circuit 108 may retain a registration context REG_CON of the electronic device 10 (more particularly, the RF SoC 102) with respect to the network device 200, in order to save the time for re-registration with the network device 200. That is, the context related to a layer 4 (L4) protocol module and a non-access stratum (NAS) protocol module of the modem circuit 106 (denoted by a context CON_L4_NAS) can be retained in the memory device 110. Furthermore, before the RF SoC 102 is powered off, the processing circuit 108 may be further arranged to shut down a timer of the modem circuit 106, and retain a shut-downed timer in the memory device 110 for acting as timer information TIMER_INF. As a result, the at least one boot up information BOOT_INF may include the registration context REG_CON, the context CON_L4_NAS, and the timer information TIMER_INF in the stage STAGE2.

Compared with the stage STAGE2, in the stage STAGE3, the processing circuit 108 may be further arranged to perform a data plane context retention, and retain a packet data network (PDN) and a protocol data unit (PDU) in the memory device 110, in order to save the time for establishing the PDN/PDU with the network device 200, wherein the at least one boot up information BOOT_INF may further include the PDN, the PDU, and the data plane context in the stage STAGE3.

After the retention operation is completed, the RF SoC 102 may transmit a fast boot response FAB_RES to the AP 100 for indicating that the RF SoC 102 is ready to be powered off. Afterwards, the RF SoC 102 is powered off and the at least one boot up information BOOT_INF is retained in the memory device 110 (labeled as “Power off with memory retention” in FIG. 2). BOOT_INF, the processing circuit 108 may implement a security mechanism to encrypt/protect the at least one boot information BOOT_INF, for generating encrypted/protected information. For example, the processing circuit 108 may perform a hash operation upon the at least one boot information BOOT_INF in order to generate hash information. In the subsequent leaving phase of the fast boot mode, the processing circuit 108 may check the hash information to ensure the security of the boot process. In this way, via the hash operation, data can be protected from tampering and abnormal data loss can be avoided.

In addition, the RF SoC 102 (more particularly, the L4 protocol module of the modem circuit 106) may be further arranged to detect whether an abnormal case occurs before the RF SoC 102 is powered on. In response to the abnormal case occurring, the L4 protocol module may notify the processing circuit 108 of performing a fallback operation in order to make the electronic device 10 switched from the fast boot mode to a cold boot mode. Specifically, after the fast boot request FAB_REQ indicating that the electronic device 10 prepares to enter the fast boot mode is received, the L4 protocol module may provide an application programming interface (API) to notify each protocol module in the modem circuit 106 of a current stage of the fast boot mode which is implemented by the processing circuit 108, and query each protocol module a status response with respect to the current stage of the fast boot mode. For example, under a condition that the stage STAGE2 is implemented by the processing circuit 108, each protocol module in the modem circuit 106 may determine whether to be ready to enter the fast boot mode with the registration context REG_CON retention. If any protocol module in the modem circuit 106 determines that implementing the stage STAGE2 of the fast boot mode causes an abnormal case (e.g., an asynchronous behavior of the network device 200) to occur, the protocol module may send a non-ok response to the API. In this case, the processing circuit 108 may implement no stage STAGE2 but stage STAGE1 during the leaving phase of the fast boot mode. For example, the registration context REG_CON originally retained in the memory device 110 may be reset, and the RF SoC 102 may perform an initial registration procedure of the cold boot mode with the network device 200. That is, the electronic device 10 may be booted up according to the at least one boot up information BOOT_INF corresponding to the stage STAGE1 (e.g., the NV data retrieved from the AP 100 and the data read/accessed from the SIM).

For another example, under a condition that the stage STAGE3 is implemented by the processing circuit 108, each protocol module in the modem circuit 106 may determine whether the modem circuit 106 determines that implementing the stage STAGE3 of the fast boot mode causes an abnormal case (e.g., an asynchronous behavior of the network device 200) to occur, the protocol module may send a non-ok response to the API. In this case, the processing circuit 108 may implement no stage STAGE3 but stage STAGE1 during the leaving phase of the fast boot mode. For example, the PDN/DPU originally retained in the memory device 110 may be reset, and the RF SoC 102 may perform an initial registration procedure of the cold boot mode with the network device 200.

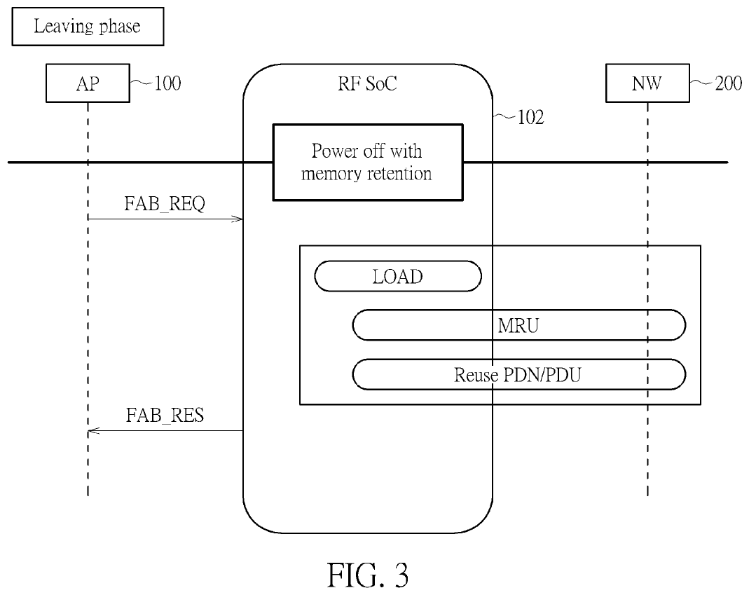

FIG. 3 is a diagram illustrating a leaving phase of a fast boot mode with a retention mechanism according to an embodiment of the present invention. The AP 100 may control a voltage level of the control signal MODE_CTL in order to switch the mode of the electronic device 10 from the fast boot mode back to the normal mode. For example, in response to the voltage level of the control signal MODE_CTL being switched from a low level to a high level, the PMIC 104 may boot the RF SoC 102 and make the electronic device 10 enter a leaving phase of the fast boot mode. The AP 100 may be further arranged to transmit the fast boot request FAB REQ to the RF SoC 102, wherein the fast boot request FAB_REQ may be modified to indicate that the RF SoC 102 is able to be powered on. After receiving the fast boot request FAB_REQ, the processing circuit 108 may load the at least one boot up information BOOT_INF from the memory device 110 (labeled as “LOAD” in FIG. 3), and perform at least one activation/recovery operation according to the at least one boot up information BOOT_INF for the power on event. For example, the processing circuit 108 may read retained SIM data from the memory device 110 for activating the SIM. For another example, the processing circuit 108 may read the registration context REG_CON from the memory device 110, and perform a mobility registration update (MRU) procedure with the network device 200 by reusing the registration context REG_CON.

After the MRU procedure is performed, the processing circuit 108 may be further arranged to activate a PDN/PDU (e.g., establish the PDN/PDU with the network device 200) by reusing the retained PDN/PDU in the memory device 110. In detail, by performing the MRU procedure with the network device 200, the processing circuit 108 may be informed which PDN/PDU is still available, and may thereby perform an error handling operation in order to avoid discrepancies between the PDN/PDU information of the RF SoC 102 and that of the AP 100. PDN/PDU is de-activated by the network device 200), the processing circuit 108 may notify the AP 100 of the disconnection of the PDN/PDU in order to achieve synchronization of the PDN/PDU status between the RF SoC 102 and the AP 100. If the processing circuit 108 is informed that none of the PDNs/PDUs has been disconnected, the processing circuit 108 may wait for the AP 100 to activate the PDN/PDU. For example, under a condition that the AP 100 activates a new PDN/PDU, the processing circuit 108 may establish the PDN/PDU. Under a condition that a PDN/PDU that the AP 100 requires to activate is an old PDN/PDU (e.g., the PDN/PDU is the same as one of the retained PDNs/DPUs in the memory device 110), the processing circuit 108 may reuse the retained PDN/PDU to complete the establishment of the PDN/PDU. If the processing circuit 108 determines that a PDN/PDU which the AP 100 requires to activate is old but cannot be reused, the processing circuit 108 may re-establish the PDN/PDU with the network device 200. After all of the PDNs/PDUs have been established, the processing circuit 108 may bind a network interface and confirm the network interface with the AP 100.

In addition, the processing circuit 108 may implement a protection mechanism for unused PDNs/PDUs. For example, if the AP 100 does not activate a PDN/PDU, the processing circuit 108 may release the PDN/PDU, which ensures that the PDN/PDU recognized by the network device 200 and the RF SoC 102 is consistent with that recognized by the AP 100 and the RF SoC 102.

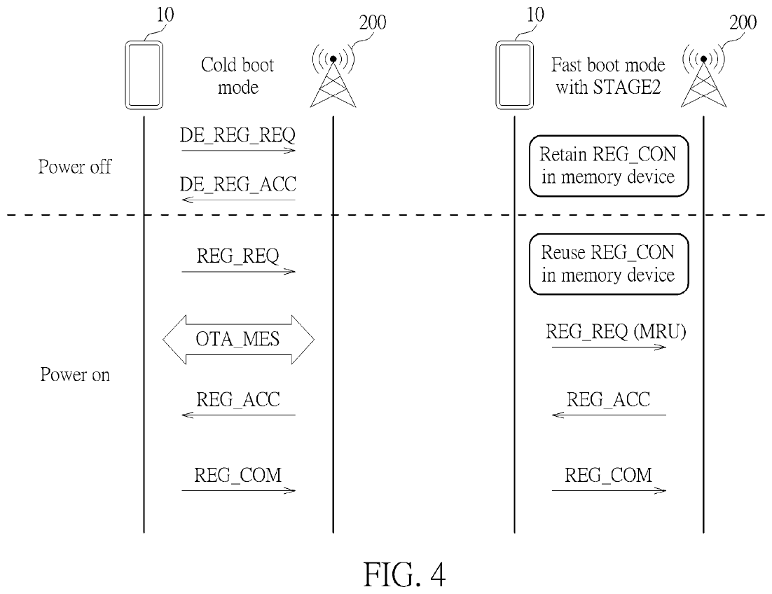

FIG. 4 is a diagram illustrating a registration status between the electronic device 10 and the network device 200 according to an embodiment of the present invention, wherein the left half of FIG. 4 shows interaction between the electronic device 10 and the network device 200 when the electronic device 10 is in a cold boot mode, and the right half of FIG. 4 shows interaction between the electronic device 10 and the network device 200 when the electronic device 10 is in a fast boot mode with the stage STAGE2.

As shown in FIG. 4, under a condition that the electronic device 10 is in the cold boot mode, before the RF SoC 102 is powered off, the electronic device 10 is required to perform a de-registration procedure with the network device 200. For example, the electronic device 10 may transmit a de-registration request DE_REG_REQ to the network device 200. In response to reception of the de-registration request DE_REG_REQ, when being ready to perform the de-registration procedure, the network device 200 may transmit a de-registration accept device 10 is required to perform an initial registration procedure with the network device 200. Specifically, the electronic device 10 may transmit a registration request REG_REQ to the network device 200, and perform multiple over-the-air (OTA) messages transception with the network device 200 for verification of an authentication, an identity, and a security mode. When being ready to perform the initial registration procedure, the network device 200 may transmit a registration accept REG_ACC to the electronic device 10. When the initial registration procedure is completed by the electronic device 10, the electronic device 10 may transmit a registration complete REG_COM to the network device 200.

Under a condition that the electronic device 10 is in the fast boot mode with the stage STAGE2, before the RF SoC 102 is powered off, the processing circuit 108 may retain the registration context REG_CON in the memory device 110. When the RF SoC 102 is powered on, the processing circuit 108 may transmit the registration request REG_REQ to the network device 200, and more particularly, may perform an MRU procedure with the network device 200 by reusing the registration context REG_CON. Afterwards, the network device 200 may transmit the registration accept REG_ACC to the electronic device 10. When the registration procedure is completed by the electronic device 10, the electronic device 10 may transmit the registration complete REG_COM to the network device 200. As a result, the RF SoC 102 of the present invention can save the time for performing de-registration procedure and transceiving the OTA messages between the electronic device 10 and the network device 200 with aid of the retention mechanism, which can greatly optimize the boot time of the electronic device 10.

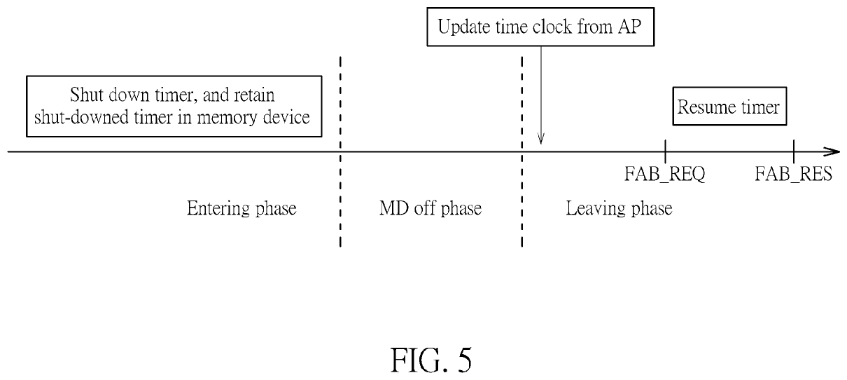

FIG. 5 is a diagram illustrating a resume mechanism of a timer according to an embodiment of the present invention. In this embodiment, the operations performed by the processing circuit 108 upon the timer in the modem circuit 106 may be illustrated in three phases of the fast boot mode (i.e., the entering phase, a modem off phase, and the leaving phase), wherein the modem off phase represents the phase in which the modem circuit 106 is powered off. As shown in FIG. 5, during the entering phase (i.e., before the RF SoC 102 is powered off), the processing circuit 108 may shut down the timer of the modem circuit 106 and retain the shut-downed timer in the memory device 110 for acting as the timer information TIMER_INF. During the leaving phase (i.e., when the RF SoC 102 is powered on), the processing circuit 108 may read the timer information TIMER_INF (i.e., the shut-downed timer) from the memory device 110, and resume and restart the shut-downed timer. In this embodiment, the processing circuit 108 may receive that the RF SoC 102 is able to be powered on, the processing circuit 108 may start to resume and restart the shut-downed timer according to the clock information, and then transmit the fast boot response FAB_RES to the AP 100. In some embodiments, the processing circuit 108 may obtain the clock information from the modem circuit 106 during the modem off phase, and then resume and restart the shut-downed timer according to the clock information during the leaving phase.

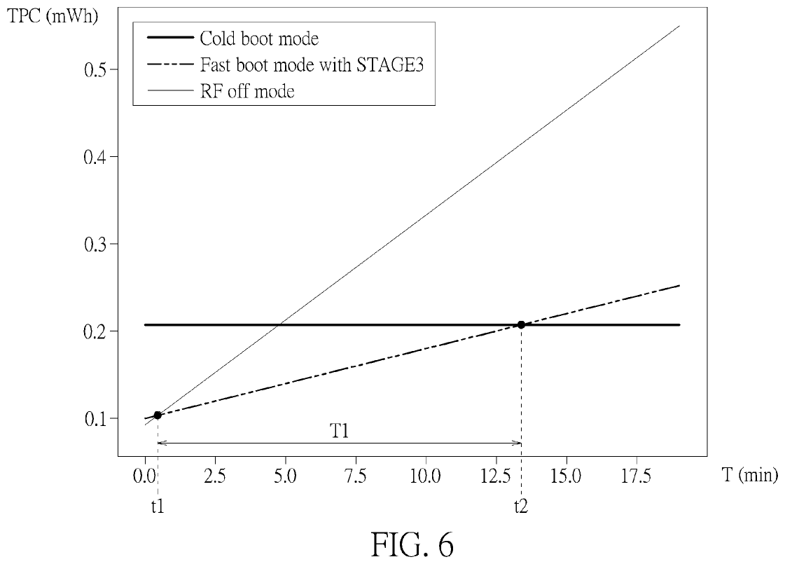

FIG. 6 is a diagram illustrating power consumption of different boot modes of the electronic device 10 according to an embodiment of the present invention, wherein the diagram has a horizontal axis showing a time duration in which the electronic device 10 is powered off in units of minutes (labeled as “T (min)” in FIG. 6 for brevity), and a vertical axis showing a total power consumption in units of milliwatt-hour (mWh) (labeled as “TPC (mWh)” in FIG. 6 for brevity), and the total power consumption includes the power consumed during the power-off period and the power consumed to recover to the normal service during the boot-up process. The boot modes of the electronic device 10 may include the cold boot mode, the fast boot mode with the Stage STAGE3, and an RF on/off mode, wherein in the RF on/off mode, the RF SoC 102 is not powered off during a power off event of the electronic device 10; and in the cold boot mode, some modem contexts stored in the memory device 110 may be reset to 0's before the electronic device 10 is powered on. As shown in FIG. 6, during a short time period after the electronic device 10 is powered off (e.g., a time period T1 from a time point t1 to a time point t2), the cold boot mode and the RF off mode may cause higher power consumption than the fast boot mode with the Stage STAGE3. That is, the fast boot mode with the Stage STAGE3 among the above three boot modes has the lowest power consumption during the time period T1.

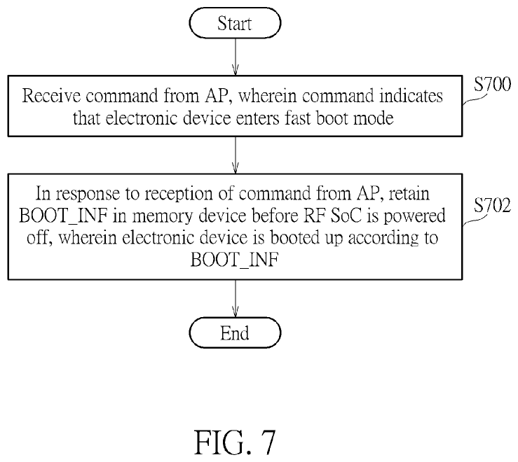

FIG. 7 is a flow chart of a method for booting up an electronic device (e.g., the electronic device 10 shown in FIG. 1) with aid of a retention mechanism according to an embodiment of the present invention. Provided that the result is substantially the same, the steps are not required to be executed in the exact order shown in FIG. 7. For example, the method shown in FIG. 7 may be employed by the processing circuit 108 shown in FIG. 1.

In Step S700, a command is received from the AP 100, wherein the command indicates that the electronic device 10 enters a fast boot mode.

In Step S702, in response to reception of the command from the AP 100, the at least one powered off, wherein the electronic device 10 is booted up according to the at least one boot up information BOOT_INF.

Since a person skilled in the pertinent art can readily understand details of the steps after reading above paragraphs directed to the processing circuit 108 shown in FIG. 1, further description is omitted here for brevity.

In summary, an RF SoC of the present invention and an associated method can achieve fast boot up of an electronic device with aid of a retention mechanism, which can accelerate the boot time and achieve lower power consumption for re-booting during a short time period after the electronic device is powered off. In addition, compared with a case where the electronic device frequently enters a cold boot mode or an RF on/off mode, the electronic device equipped with the RF SoC of the present invention will not transmit a large number of OTA messages to a network device, which can greatly release a burden on the network device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system on chip (SoC), comprising:
a memory device; and
a processing circuit, arranged to retain at least one boot up information in the memory device before the SoC is powered off in response to a command from an application processor (AP), wherein the command indicates that an electronic device comprising the SoC enters a fast boot mode, and the electronic device is booted up according to the at least one boot up information.

2. The SoC of claim 1, wherein the processing circuit preloads non-volatile (NV) data from the AP to the memory device for acting as the at least one boot up information.

3. The SoC of claim 1, wherein the at least one boot up information comprises data read from a subscriber identity module (SIM).

4. The SoC of claim 1, wherein the at least one boot up information comprises registration context of the electronic device with respect to a network device.

5. The SoC of claim 4, wherein when the SoC is powered on, the registration context is reused for registration between the electronic device and the network device.

6. The SoC of claim 1, wherein the at least one boot up information comprises a packet data network (PDN) and a protocol data unit (PDU).

7. The SoC of claim 1, wherein the processing circuit is further arranged to perform a hash operation upon the at least one boot up information in order to generate hash information.

8. The SoC of claim 1, wherein the at least one boot up information comprises timer information.

9. The SoC of claim 8, wherein before the SoC is powered off, a timer is shut down and the processing circuit retains a shut-downed timer in the memory device for acting as the timer information; and when the SoC is powered on, the processing circuit resumes and

10. The SoC of claim 1, wherein the SoC is further arranged to detect whether an abnormal case occurs before the SoC is powered on; and in response to the abnormal case occurring, the electronic device is switched from the fast boot mode to a cold boot mode.

11. A method for booting up an electronic device, comprising:
receiving a command from an application processor (AP), wherein the command indicates that the electronic device enters a fast boot mode; and
in response to reception of the command from the AP, retaining at least one boot up information in a memory device before the electronic device is powered off, wherein the electronic device is booted up according to the at least one boot up information.

12. The method of claim 11, wherein the step of retaining the at least one boot up information in the memory device before the electronic device is powered off further comprises:
preloading non-volatile (NV) data from the AP to the memory device for acting as the at least one boot up information.

13. The method of claim 11, wherein the at least one boot up information comprises data read from a subscriber identity module (SIM).

14. The method of claim 11, wherein the at least one boot up information comprises registration context of the electronic device with respect to a network device.

15. The method of claim 14, further comprising:
in response to the SoC being powered on, reusing the registration context for registration between the electronic device and the network device.

16. The method of claim 11, wherein the at least one boot up information comprises a packet data network (PDN) and a protocol data unit (PDU).

17. The method of claim 11, further comprising:
performing a hash operation upon the at least one boot up information in order to generate hash information.

18. The method of claim 11, wherein the at least one boot up information comprises timer information.

19. The method of claim 18, further comprising:
before the SoC is powered off, shutting down a timer retaining shut-downed timer in the memory device for acting as the timer information; and
in response to the SoC being powered on, resuming and restarting the shut-downed timer in the memory device.

20. The method of claim 11, further comprising:
detecting whether an abnormal case occurs before the SoC is powered on; and
in response to the abnormal case occurring, switching the electronic device from the fast boot mode to a cold boot mode.

21. An electronic device, comprising:
an application processor (AP), arranged to generate a command for indicating that the electronic device enters a fast boot mode; and
a system on chip (SoC), comprising:
a memory device; and
a processing circuit, wherein in response to reception of the command from the AP, the processing circuit retains at least one boot up information in the memory device before the electronic device is powered off, and the electronic device is booted up according to the at least one boot up information.
